(19) United States
(12) Patent Application Publication
(10) Pub. No.: US 2025/0384201 A1
(43) Pub. Date: Dec. 18, 2025

(54) SUMMARY GENERATION SYSTEM, SUMMARY GENERATION METHOD, AND RECORDING MEDIUM RECORDING SUMMARY GENERATION PROGRAM

(71) Applicant: SHARP KABUSHIKI KAISHA, Sakai City (JP)

(72) Inventors: Hiroko KAWAKAMI, Sakai City (JP); Satoshi Terada, Sakai City (JP)

(21) Appl. No.: 19/212,674

(22) Filed: May 20, 2025

(30) Foreign Application Priority Data
Jun. 12, 2024 (JP) 2024-094945

(51) Int. Cl. G06F 40/166; G06F 40/205

(52) U.S. Cl. CPC G06F 40/166; G06F 40/205

(57) ABSTRACT

A summary generation system includes: an acquisition processing unit that acquires text data; a first summary generation processing unit that parses a text in the text data acquired by the acquisition processing unit and generates a first summary including a specific word; a second summary generation processing unit that generates a second summary of the text data using a summary generation model generated by machine learning; and an integration processing unit that integrates the first summary and the second summary and generates a summary corresponding to the text data.

### INCORPORATION BY REFERENCE

This application is based upon and claims the benefit of priority from the corresponding Japanese Patent Application No. 2024-094945 filed on Jun. 12, 2024, the entire contents of which are incorporated herein by reference.

### BACKGROUND

The present disclosure relates to a technique for generating a summary from text data.

There is a known system that generates a summary from text data. For example, there is a known system that obtains importance of a word included in an original text, inputs the importance to a learned model, and generates a summary of the original text.

However, in the related art, since a summary is generated using a learned model (AI model) machine-learned with learning data (supervised data), there is a problem that the accuracy of a generated summary is low, such as being easily affected by the tendency of learning data and falsely recognizing a specific word.

### SUMMARY

An object of the present disclosure is to provide a summary generation system that can generate a highly accurate summary from text data, a summary generation method that can generate a highly accurate summary from text data, and a recording medium recording a summary generation program that can generate a highly accurate summary from text data.

A summary generation system according to one aspect of the present disclosure includes: an acquisition processing unit that acquires text data; a first summary generation processing unit that generates a first summary including a specific word included in the text data, based on the text data acquired by the acquisition processing unit; a second summary generation processing unit that generates a second summary of the text data using a summary generation model generated by machine learning; and an integration processing unit that integrates the first summary and the second summary and generates a summary corresponding to the text data.

A summary generation method according to another aspect of the present disclosure is a summary generation method for one or more processors to execute: acquiring text data; generating a first summary including a specific word included in the text data, based on the text data; generating a second summary of the text data using a summary generation model generated by machine learning; and integrating the first summary and the second summary and generating a summary corresponding to the text data.

A non-transitory computer-readable recording medium according to another aspect of the present disclosure is a non-transitory computer-readable recording medium recording a summary generation program for causing one or more processors to execute: acquiring text data; generating a first summary including a specific word included in the text data, based on the text data; generating a second summary of the text data using a summary generation model generated by machine learning; and integrating the first summary and the second summary and generating a summary corresponding to the text data.

According to the present disclosure, it is possible to provide a summary generation system that can generate a highly accurate summary from text data, a summary generation method that can generate a highly accurate summary from text data, and a recording medium recording a summary generation program that can generate a highly accurate summary from text data.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating a configuration of a summary generation system according to an embodiment of the present disclosure.

FIG. 2 is a view illustrating an example of text data acquired in the summary generation system according to the embodiment of the present disclosure.

FIG. 3 is a view illustrating an example of a syntax summary generated in the summary generation system according to the embodiment of the present disclosure.

FIG. 4 is a view illustrating an example of an AI summary generated in the summary generation system according to the embodiment of the present disclosure.

FIG. 5 is a view illustrating an example of a complete summary generated in the summary generation system according to the embodiment of the present disclosure.

FIG. 6 is a view illustrating an example of a determination result page displayed in the summary generation system according to the embodiment of the present disclosure.

FIG. 7 is a flowchart for describing an example of a procedure of summary generation processing executed in the summary generation system according to the embodiment of the present disclosure.

FIG. 8 is a view illustrating an example of a determination result page displayed in the summary generation system according to the embodiment of the present disclosure.

### DETAILED DESCRIPTION

Embodiments of the disclosure will be described below with reference to the drawings. Note that the following embodiments are specific examples of the disclosure, and do not limit the technical scope of the disclosure.

The summary generation system according to the present disclosure can be applied to a case where voice data of a meeting, for example, is transcribed and converted into text data, and a summary of the content of the meeting is generated from the text data. Note that the text data is not limited to text data in which voice data is converted into characters, and may be, for example, text data input by a meeting participant into a user terminal (PC), text data in which character recognition is performed on a document image scanned by an image forming device, or text data in which a text in another language is translated.

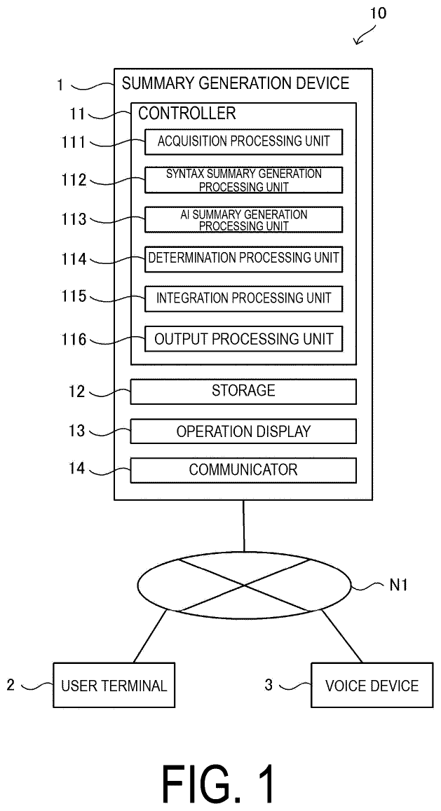

FIG. 1 is a block diagram illustrating a configuration of a summary generation system 10 according to the present embodiment. As illustrated in FIG. 1, the summary generation system 10 includes a summary generation device 1, a user terminal 2, and a voice device 3. The user terminal 2 is an information processing device such as a personal computer or a smartphone, and the voice device 3 is audio equipment of wireless or wired connection type (microphone speaker device) mounted with a microphone and a speaker. The summary generation device 1 can perform data communication with the user terminal 2 and the voice device 3 via a network N1. For example, the summary generation device 1 can acquire text data or a document file (e.g., minutes) from the user terminal 2, and can acquire voice data of speech voice (e.g., meeting voice) or text data in which the voice is converted into text from the voice device 3.

The summary generation system 10 may be constituted by the summary generation device 1 alone, may be constituted by a combination of the summary generation device 1 and the user terminal 2, or may be constituted by a combination of the summary generation device 1 and the voice device 3.

### Summary Generation Device 1

As illustrated in FIG. 1, the summary generation device 1 is an information processing device including a controller 11, a storage 12, an operation display 13, and a communicator 14. The summary generation device 1 may be constituted by a personal computer or may be constituted by one or more servers (e.g., cloud servers).

The communicator 14 is a communicator for connecting the summary generation device 1 to the network N1 in a wired or wireless manner and executing data communication according to a predetermined communication protocol with external equipment such as the user terminal 2 or the voice device 3 via the network N1.

The operation display 13 is a user interface including a display such as a liquid crystal display or an organic EL display that displays various types of information, and an operation unit such as a mouse, a keyboard, or a touch panel that receives an operation. The operation display 13 receives an operation of an administrator of the summary generation device 1.

The storage 12 is a non-volatile storage such as a hard disk drive (HDD), a solid state drive (SSD), or a flash memory that stores various types of information. The storage 12 stores text data input from the user terminal 2, voice data input from the voice device 3, text data in which voice data is transcribed, and the like. The storage 12 stores data of a summary generated by the controller 11.

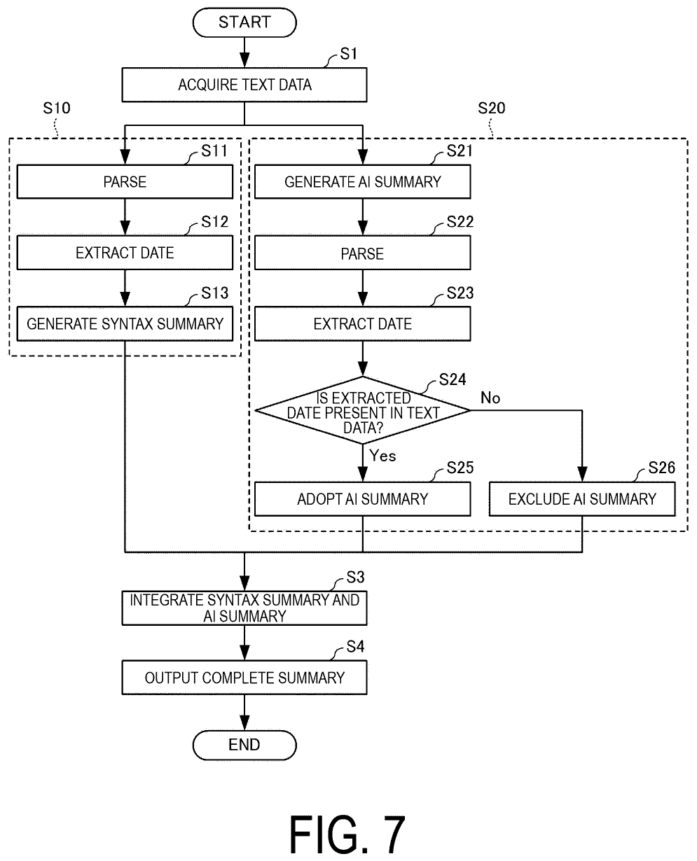

The storage 12 stores a control program such as a summary generation program (an example of the summary generation program of the present disclosure) for causing the controller 11 to execute summary generation processing (see FIG. 7) described later. For example, the summary generation program may be recorded non-transitorily on a computer-readable recording medium such as a CD or a DVD, read by a reading device (not illustrated) such as a CD drive or a DVD drive included in the summary generation device 1, and stored in the storage 12.

The controller 11 includes control equipment such as a central processing unit (CPU), a read only memory (ROM), and a random access memory (RAM). The CPU is a processor that executes various types of arithmetic processing. The ROM is non-volatile storage that stores, in advance, control programs such as a basic input/output system (BIOS) and an operating system (OS) for causing the CPU to execute various types of arithmetic processing. The RAM is a volatile or non-volatile storage that stores various types of information and is used as a temporary storage memory (work area) for the various types of processing executed by the CPU. Then, the controller 11 controls the summary generation device 1 by executing, using the CPU, various control programs stored in advance in the ROM or the storage 12.

Specifically, as illustrated in FIG. 1, the controller 11 includes various processing units such as an acquisition processing unit 111, a syntax summary generation processing unit 112, an AI summary generation processing unit 113, a determination processing unit 114, an integration processing unit 115, and an output processing unit 116. Note that the controller 11 functions as the various types of processing units by executing various types of processing in accordance with the control program using the CPU. Some or all of the processing units may be constituted by an electronic circuit. Note that the control programs may be programs for causing multiple processors to function as the processing units.

The acquisition processing unit 111 acquires text data. For example, when a voice in a meeting is input to the voice device 3, the voice device 3 transcribes the voice, converts it into text, and outputs text data to the summary generation device 1. The acquisition processing unit 111 acquires the text data from the voice device 3. As another embodiment, the acquisition processing unit 111 acquires text data corresponding to a document input to the user terminal 2.

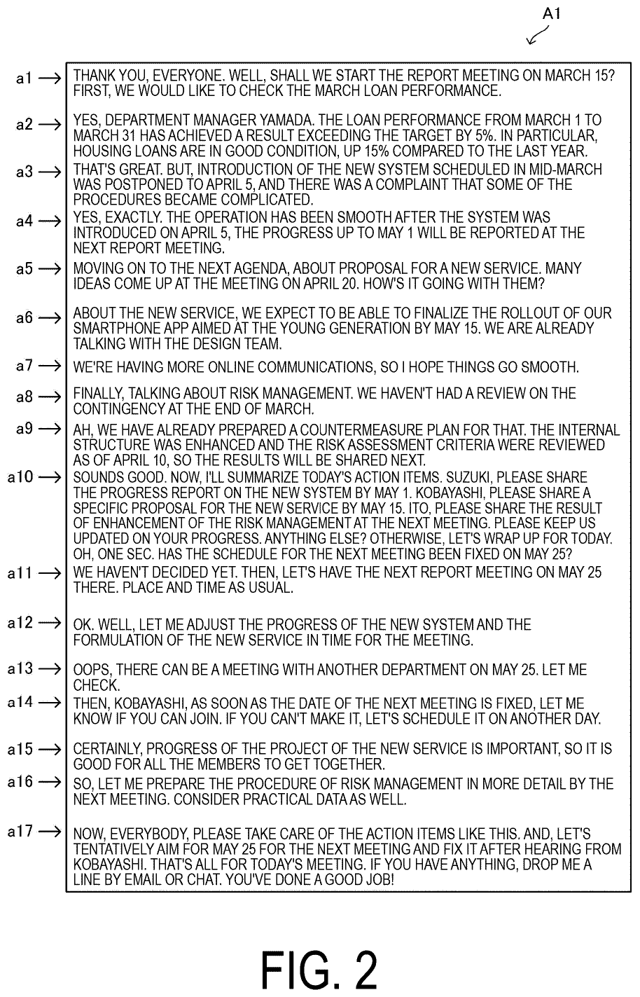

FIG. 2 illustrates a specific example of the text data A1 corresponding to a voice in a specific meeting. The text data A1 includes a plurality of passages a1 to a17 segmented for each speaker. Each passage may include a plurality of sentences or may include one sentence.

The syntax summary generation processing unit 112 generates a summary including a specific word included in text data, based on the text data acquired by the acquisition processing unit 111. Specifically, the syntax summary generation processing unit 112 parses a text in the text data acquired by the acquisition processing unit 111 to extract the specific word, and generates a summary (hereinafter, called “syntax summary”) including the extracted specific word. The syntax summary is an example of the first summary of the present disclosure. Here, the specific word is a word of high importance in the text data, and is set according to attributes such as content and type of the text data. Here, it is assumed that “date” is set to the specific word for the text data A1. Note that the specific word may be set by the administrator of the summary generation device 1 or may be automatically set by the controller 11. A specific example of a setting method of the specific word will be described later.

In the text data A1 illustrated in FIG. 2, the syntax summary generation processing unit 112 first extracts a passage including a date, which is the specific word, from among passages a1 to a17. Next, the syntax summary generation processing unit 112 converts each extracted passage into a predetermined format, for example, a form of “date: event”. The event corresponds to the speech content of the speaker, and is a concise expression of the speech content in one sentence. The syntax summary generation processing unit 112 may generate the event by omitting a particle, a conjunction, or the like, representing a verb in a base form, and the like.

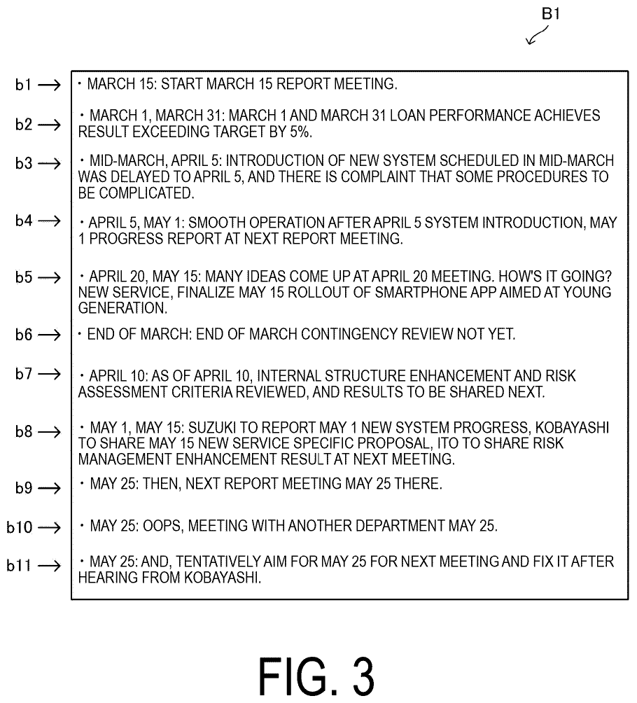

The syntax summary generation processing unit 112 generates a syntax summary represented in the form of “date: event”. FIG. 3 illustrates a specific example of a syntax summary B1 generated by the syntax summary generation processing unit 112. Here, syntax summaries b1 to b11 corresponding to the passages a1 to a17 of the text data A1 (see FIG. 2) are illustrated. For example, the syntax summary generation processing unit 112 generates the syntax summary b1, based on the passage a1, generates the syntax summary b2, based on the passage a2, and generates the syntax summary b6, based on the passage a8. The syntax summary generation processing unit 112 excludes passages not including a date (e.g., passages a7, a12, a14, a15, and a16) from the target of the syntax summary.

The syntax summary generation processing unit 112 generates, as a syntax summary, one sentence including at least one specific word. For example, the syntax summary generation processing unit 112 extracts one date and generates a syntax summary of one sentence (e.g., the syntax summaries b1, b6, b7, and b9 to b11) in a case where one passage includes only one date word, and extracts a plurality of dates and generates a syntax summary of one sentence (e.g., the syntax summaries b2 to b5 and b8) in a case where one passage includes a plurality of date words.

In this manner, the syntax summary generation processing unit 112 extracts a passage including a specific word (here, “date”) from among the passages a1 to a17 and generates the syntax summary B1 (b1 to b11) represented in a predetermined format. The syntax summary generation processing unit 112 is an example of the first summary generation processing unit of the present disclosure.

The AI summary generation processing unit 113 generates a summary (hereinafter, called “AI summary”) of text data using a summary generation model (AI model) generated by machine learning. The AI summary is an example of the second summary of the present disclosure. For example, the summary generation model is generated by performing machine learning on learning data of various text data. The summary generation model may be generated by the summary generation device 1 or may be generated by external equipment (learning device) and downloaded to the summary generation device 1. The summary generation device 1 may use the summary generation model by accessing a cloud server such as the learning device.

Note that the machine learning involves algorithms such as supervised learning using supervised data, unsupervised learning using unsupervised data, and reinforcement learning. Further, in order to realize these techniques, a method called “deep learning” is used in which extraction of a feature amount itself is learned. In the present embodiment, a learned model based on the above-described various algorithms is included. For example, machine learning is performed with the supervised data and the unsupervised data as input data (learning data), and a summary generation model for executing summary generation processing is generated. In the present embodiment, the AI summary generation processing unit 113 may use a known summary generation model.

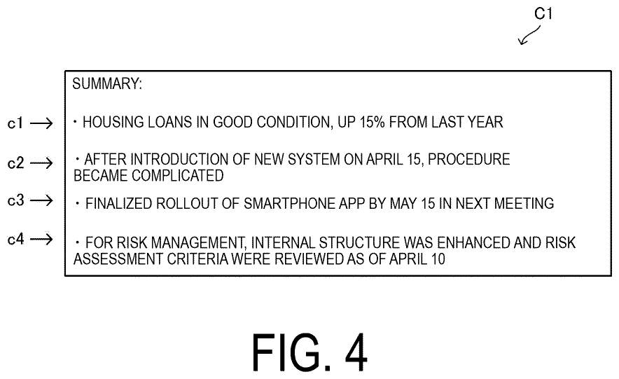

FIG. 4 illustrates a specific example of an AI summary C1 generated by the AI summary generation processing unit 113. Here, AI summaries c1 to c4 corresponding to the passages a1 to a17 of the text data A1 (see FIG. 2) are illustrated. The AI summary generation processing unit 113 inputs the passages a1 to a17 to the summary generation model and acquires the AI summaries c1 to c4 generated by the summary generation model. The AI summaries c1 to c4 are new passages created based on the passages a1 to al7.

In this manner, the AI summary generation processing unit 113 generates one or more AI summaries by using all passages in the text data A1. Here, the AI summary generation processing unit 113 may generate an AI summary of one sentence including a specific word and an AI summary of one sentence not including a specific word. In the example illustrated in FIG. 4, the AI summary generation processing unit 113 generates the AI summaries c2 to c4 including a date and the AI summary c1 not including a date. The AI summary generation processing unit 113 is an example of the second summary generation processing unit of the present disclosure.

Here, an AI model (learned model) such as the summary generation model has a problem of being easily affected by the tendency of learning data and falsely recognizing a specific word. For example, when text data including a date is input to the summary generation model to generate a summary, the date may be falsely recognized. Falsely recognizing an important word included in the text data impairs the reliability of the summary. On the other hand, the present embodiment includes processing of determining falsehood in the date for an AI summary generated by the AI summary generation processing unit 113.

Specifically, when the AI summary includes a specific word (here, date), the determination processing unit 114 determines whether or not the date is correct with reference to the text data. Specifically, the determination processing unit 114 extracts a date by parsing the AI summary C1 (see FIG. 4) generated by the AI summary generation processing unit 113. For example, the determination processing unit 114 extracts the date by parsing each of the AI summaries c1 to c4. Here, the determination processing unit 114 extracts “April 15” from the AI summary c2, extracts “May 15” from the AI summary c3, and extracts “April 10” from the AI summary c4. Since the AI summary c1 does not include a date, the determination processing unit 114 excludes the AI summary c1 from a determination target.

Next, the determination processing unit 114 determines whether or not the date “April 15” extracted from the AI summary c2 is included in the text data A1 (see FIG. 2). Here, the determination processing unit 114 determines that the date “April 15” is not included in any of the passages a1 to a17 of the text data A1.

Similarly, the determination processing unit 114 determines whether or not the date “May 15” extracted from the AI summary c3 is included in the text data A1. Here, the determination processing unit 114 determines that the date “May 15” is included in the passage a6 of the text data A1. The determination processing unit 114 determines that the date “April 10” extracted from the AI summary c4 is included in the passage a9 of the text data A1. Therefore, the determination processing unit 114 determines that “April 15” is false, and determines that “May 15” and “April 10” are correct.

The determination processing unit 114 determines that the AI summary including a specific word is correct when the text data includes a word matching the specific word, and determines that the AI summary including the specific word is false when the text data does not include a word matching the specific word. For example, since the date “May 15” extracted from the AI summary c3 matches the date included in the passage a6 of the text data A1, the determination processing unit 114 determines that the AI summary c3 is correct. Since the date “April 10” extracted from the AI summary c4 matches the date included in the passage a9 of the text data A1, the determination processing unit 114 determines that the AI summary c4 is correct. On the other hand, since the date “April 15” extracted from the AI summary c2 does not match any date included in the text data A1, the determination processing unit 114 determines that the AI summary c2 is false.

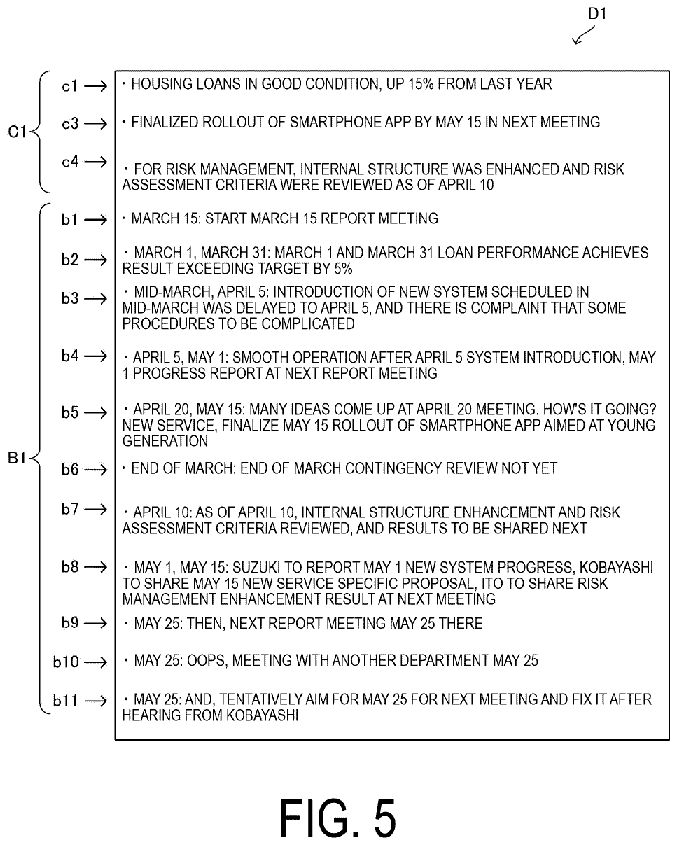

The integration processing unit 115 integrates the syntax summary generated by the syntax summary generation processing unit 112 and the AI summary generated by the AI summary generation processing unit 113, and generates a summary (complete summary) corresponding to text data. Specifically, the integration processing unit 115 integrates the syntax summary B1 (see FIG. 3) generated by the syntax summary generation processing unit 112, based on the text data A1 (see FIG. 2) and the AI summary C1 (see FIG. 4) generated by the AI summary generation processing unit 113, based on the text data A1 (see FIG. 2), and generates a complete summary D1 (see FIG. 5) corresponding to the text data A1.

Here, when the determination processing unit 114 determines that the specific word (date) is false, the integration processing unit 115 excludes the corresponding AI summary and generates the complete summary. For example, in the above example, since the determination processing unit 114 determines that the AI summary c2 is false, the integration processing unit 115 excludes the AI summary c2 from among the AI summaries c1 to c4 and generates the complete summary D1 (see FIG. 5) in which the remaining AI summaries c1, c3, and c4 and the syntax summaries b1 to b11 are put together.

In this manner, when the AI summary generation processing unit 113 generates the AI summary (e.g. the AI summaries c3 and c4) of one sentence including the specific word (date) and the AI summary (e.g., the AI summary c1) of one sentence not including the specific word, the integration processing unit 115 generates the complete summary in which the AI summary including the correct specific word, the AI summary not including the specific word, and each syntax summary (e.g., the syntax summaries b1 to b11) are integrated.

This can exclude a sentence having low reliability (AI summary c2) and generate an appropriate summary including only a sentence having high reliability.

The output processing unit 116 outputs the complete summary generated by the integration processing unit 115. For example, the output processing unit 116 causes the operation display 13 to display the complete summary D1 (see FIG. 5). For example, when an organizer of a meeting makes a generation request of a summary in the user terminal 2 of the organizer, the output processing unit 116 may transmit data of the complete summary D1 to the user terminal 2, or may cause the user terminal 2 to display a web page of the complete summary D1.

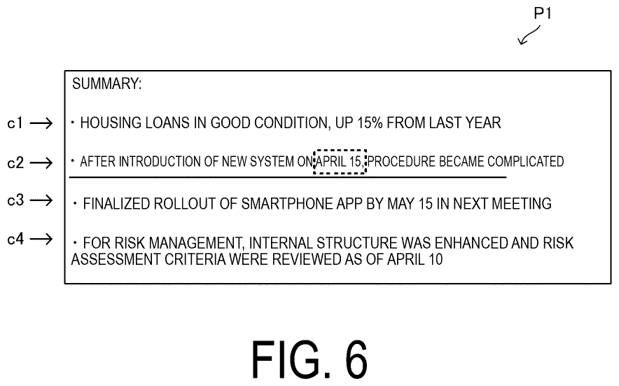

When the determination processing unit 114 determines that the specific word is false, the output processing unit 116 may cause the AI summary that is an exclusion target and the specific word to be displayed in a distinguishable manner. For example, as illustrated in FIG. 6 the output processing unit 116 causes the AI summary c2, which is determined as false by the determination processing unit 114, to be displayed on a determination result page P1 in a manner distinguishable to the user by underlining the AI summary c. On the determination result page P1, the output processing unit 116 causes the date determined as false by the determination processing unit 114 to be displayed in a manner distinguishable to the user by surrounding the date with a frame or the like. This enables the user to easily recognize a false summary and date in the AI summary.

### Summary Generation Processing

FIG. 7 illustrates an example of the procedure of the summary generation processing executed by the controller 11 of the summary generation device 1.

Note that the present disclosure can be regarded as a summary generation method (summary generation method of the present disclosure) for executing one or more steps included in the summary generation processing. One or more steps included in the summary generation processing described here may be appropriately omitted. The execution order of each step in the summary generation processing may be different in a range where similar actions and effects are produced. Furthermore, here, a case where the controller 11 executes each step in the summary generation processing will be described as an example, but in another embodiment, one or more processors may execute each step in the summary generation processing in a distributed manner.

### Step S1

First, in step S1, the controller 11 acquires text data that is a summary generation target. For example, the controller 11 acquires the text data A1 (see FIG. 2) input from external equipment, the text data A1 in which a voice in a meeting is converted into a text. As another embodiment, when the controller 11 has a voice recognition and character conversion function, the controller 11 may acquire voice data input from external equipment and convert the voice data into text data.

Upon acquiring text data, the controller 11 concurrently executes “syntax summary processing S10 (steps S11 to S13)” of parsing the text data to generate a first summary (syntax summary) including a specific word (here, “date”) and “AI summary processing S20 (steps S21 to S26)” of generating a second summary (AI summary) of the text data using a summary generation model generated by machine learning. Note that the syntax summary processing S10 and the AI summary processing S20 may be in any order.

### Step S11

In the syntax summary processing S10, the controller 11 parses a text in the text data in step S11. For each of the passages a1 to a17 in the text data A1 illustrated in FIG. 2, for example, the structure of the passage such as a word, a phrase, a symbol, a numeral (such as date and time), a subject, a predicate, a modifier, a noun, a particle, and a verb included in the passage is analyzed.

### Step S12

In step S12, the controller 11 extracts a date from a result of the parsing. For example, the controller 11 extracts “March 15” from the passage a1 of the text data A1 (see FIG. 2), extracts “March 1” and “March 31” from the passage a2, and extracts “mid-March” and “April 5” from the passage a3.

### Step S13

In step S13, the controller 11 generates a syntax summary. Specifically, the controller 11 extracts all the passages including the date from the text data A1, converts each extracted passage into the form of a predetermined format (“date: event”) using the date and the result of the parsing, and generates the syntax summary. For example, upon extracting the passage a1 including “March 15” from the text data A1, the controller 11 generates the syntax summary b1 (see FIG. 3) of “March 15: Start March 15 report meeting”. For example, upon extracting the passage a2 including “March 1” and “March 31” from the text data A1, the controller 11 generates the syntax summary b2 (see FIG. 3) of “March 1, March 31: March 1 and March 31 loan performance achieves result exceeding target by 5%”. After step S13, the controller 11 shifts the processing to step S3.

### Step S21

In the AI summary processing S20, the controller 11 generates in step S21 an AI summary based on the text data. For example, the controller 11 generates an AI summary by inputting the text data A1 (see FIG. 2) to the summary generation model (AI model) generated by machine learning. The controller 11 acquires the AI summary C1 (see FIG. 4) generated by the summary generation model.

### Step S22

In step S22, the controller 11 parses the AI summary C1 generated in step S21. For example, the controller 11 parses each of the AI summaries c1 to c4 (see FIG. 4).

### Step S23

In step S23, the controller 11 extracts a date from the result of parsing in step S22. For example, the controller 11 extracts a date from the result of parsing the AI summaries c1 to c4. Here, the controller 11 extracts “April 15” from the AI summary c2, extracts “May 15” from the AI summary c3, and extracts “April 10” from the AI summary c4.

### Step S24

In step S24, the controller 11 determines whether or not the date extracted in step S23 is included in the text data A1. Upon determining that the date is included in the text data A1 (S24: Yes), the controller 11 shifts the processing to step S25. On the other hand, upon determining that the date is not included in the text data A1 (S24: No), the controller 11 shifts the processing to step S26.

As another embodiment, the controller 11 may determine whether or not the date is included in the syntax summary B1 (see FIG. 3) generated in the syntax summary processing $10.

### Step S25

In step S25, the controller 11 adopts the AI summary as a summary to be finally output. For example, since the date “May 15” extracted from the AI summary c3 is included in the passage a6 of the text data A1 and the date “April 10” extracted from the AI summary c4 is included in the passage a9 of the text data A1, the controller 11 adopts the AI summary c3 and the AI summary c4. Note that the controller 11 also adopts, as a summary, an AI summary (e.g., the AI summary c1 illustrated in FIG. 4) not including a date in the AI summary. After step S25, the controller 11 shifts the processing to step S3.

### Step S26

In step S26, the controller 11 excludes the AI summary from the summary to be finally output. For example, since the date “April 15” extracted from the AI summary c2 is not included in any of the passages a1 to a17 of the text data A1, the controller 11 determines that the date “April 15” and the AI summary c2 are false and excludes (deletes) the AI summary c2. After step S26, the controller 11 shifts the processing to step S3.

### Step S3

In step S3, the controller 11 integrates the syntax summary generated in the syntax summary processing S10 and the AI summary generated in the AI summary processing S20.

Specifically, the controller 11 integrates the syntax summary B1 (see FIG. 3) generated based on the text data A1 (see FIG. 2) and the AI summary C1 (see FIG. 4) generated based on the text data A1 (see FIG. 2), and generates the complete summary D1 (see FIG. 5) corresponding to the text data A1. Here, the controller 11 generates the complete summary D1 (see FIG. 5) in which the AI summaries c1, c3, and c4 excluding the AI summary c2 having a false date and the syntax summaries b1 to b11 are integrated.

### Step S4

In step S4, the controller 11 outputs the integrated summary (complete summary). For example, the controller 11 causes the operation display 13 to display the complete summary D1 (see FIG. 5). As illustrated in FIG. 6, the controller 11 may cause the AI summary c2 and the date “April 15” that are determined as false to be displayed in a distinguishable display aspect on the determination result page P1.

The controller 11 executes the summary generation processing in the manner described above. The controller 11 repeatedly executes the above-described processing each time text data is acquired.

As described above, the summary generation system 10 according to the present disclosure acquires text data, parses a text in the text data, and generates a syntax summary (first summary) including a specific word. The summary generation system 10 generates an AI summary (second summary) of the text data using a summary generation model generated by machine learning. Then, the summary generation system 10 integrates the syntax summary and the AI summary and generates a summary (complete summary) corresponding to the text data. When the syntax summary includes a specific word, the summary generation system 10 determines whether or not the specific word is correct with reference to the text data, and when determining that the specific word is false, excludes the AI summary and generates the complete summary.

According to the above configuration, an accurate summary can be obtained by parsing. It is possible to determine whether or not a summary generated by the AI model is correct and obtain only a correct summary. Then, it is possible to generate a final summary by integrating an accurate summary by parsing and a falsehood-free summary generated by the AI model. Hence, it is possible to generate a highly accurate summary from text data.

### OTHER EMBODIMENTS

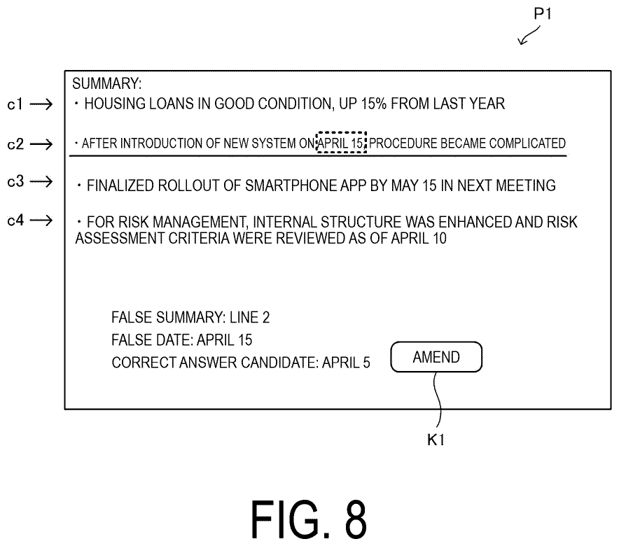

As another embodiment of the present disclosure, as illustrated in FIG. 8, the controller 11 may cause a location (e.g., “line 2”) of the AI summary c2 determined as false, the false date “April 15”, and the date “April 5”, which is a candidate for the correct answer, to be displayed on the determination result page P1. The controller 11 may cause an amendment button K1 for receiving an amendment operation on the AI summary c2 determined as false to be displayed. For example, the user can amend “April 15” to “April 5” by pressing the amendment button K1. The controller 11 may adopt, as a complete summary, the AI summary c2 that is amended.

In the above-described embodiments, the controller 11 excludes an AI summary (the AI summary c2 in the above-described example) including a date determined as false from the complete summary. However, as another embodiment, the controller 11 may exclude the syntax summary (the syntax summary b3 in FIG. 3) corresponding to the AI summary (the AI summary c2) including the date determined as false from the complete summary. The controller 11 may exclude both the AI summary c2 and the syntax summary b3. The controller 11 may exclude one of the AI summary c2 and the syntax summary b3 selected by the user.

As another embodiment, the controller 11 may amend a date determined as false to a correct date, based on text data. For example, the controller 11 specifies a syntax summary corresponding to (similar to) an AI summary including a date determined as false among a plurality of syntax summaries, and amends the date determined as false to the date included in the specified syntax summary. In this case, the controller 11 may adopt an amended AI summary as a complete summary.

In the above-described embodiments, “date” is exemplified as a specific word, but the specific word of the present disclosure is not limited to this. The controller 11 can have a configuration of not including parsing processing in extraction of a specific word. For example, the extraction may be rule-based extraction of extracting a specific word according to a specific rule, such as extracting a numeral and a word having “month” or “day”. When there is an important keyword such as a product name other than the date, it is also possible to retain candidates of the keyword and extract a specific word by matching by string-based matching. In these cases, the controller 11 may include an extracted word summary generation processing unit in place of the syntax summary generation processing unit 112 described above. The syntax summary generation processing unit 112 and the extracted word summary generation processing unit are examples of the first summary generation processing unit of the present disclosure.

For the specific word, the controller 11 may set the specific word, based on the attribute of the text data. For example, when the text data is data related to a contract, the controller 11 sets, as specific words, “provision”, “company name”, “contract period”, and the like of a contract-related law. In this manner, the controller 11 may set a specific word, based on the type of a document corresponding to text data, an agenda or a topic of a conversation, and the like. The controller 11 may set “headcount”, “proportion (%)”, “amount of money”, “product name”, and the like as specific words.

In the above-described embodiments, the controller 11 amends the amendment portion, but as another embodiment, the controller 11 may present a list of amendment content in place of directly changing the amendment content. In this case, the controller 11 may amend the corresponding portion by the user's selection operation.

### Supplementary Notes of Disclosure

Hereinafter, an outline of the disclosure extracted from the above-described embodiments will be described as supplementary notes. Note that configurations and processing functions described in the following supplementary notes can be selected and combined as desired.

### Supplementary Note 1

A summary generation system including:
an acquisition processing circuit that acquires text data;
a first summary generation processing circuit that generates a first summary including a specific word included in the text data, based on the text data acquired by the acquisition processing circuit;
a second summary generation processing circuit that generates a second summary of the text data using a summary generation model generated by machine learning; and
an integration processing circuit that integrates the first summary and the second summary and generates a summary corresponding to the text data.

### Supplementary Note 2

The summary generation system according to Supplementary Note 1, wherein
the first summary generation processing circuit parses a text in the text data to extract the specific word, and generates the first summary including the specific word.

### Supplementary Note 3

The summary generation system according to Supplementary Note 1 or 2 further comprising:
a determination processing circuit that determines whether or not the specific word is correct with reference to the text data when the second summary includes the specific word, wherein the integration processing circuit generates the summary excluding the second summary when determining that the specific word is false.

### Supplementary Note 4

The summary generation system according to Supplementary Note 3, wherein
the determination processing circuit determines that the second summary is correct when the text data includes a word matching the specific word, and determines that the second summary is false when the text data does not include a word matching the specific word.

### Supplementary Note 5

The summary generation system according to any of Supplementary Notes 1 to 4, wherein the first summary generation processing circuit generates, as the first summary, one sentence including at least one of a plurality of the specific words.

### Supplementary Note 6

The summary generation system according to Supplementary Note 3, wherein
when the second summary generation processing circuit generates the second summary of one sentence including the specific word and the second summary of one sentence not including the specific word, the integration processing circuit generates the summary in which the second summary including the specific word, that is correct, the second summary not including the specific word, and the first summary are integrated.

### Supplementary Note 7

The summary generation system according to Supplementary Notes 3, 4, or 6 further comprising:
an output processing circuit that outputs the summary generated by the integration processing circuit, wherein
when the determination processing circuit determines that the specific word is false, the output processing circuit causes the second summary that is an exclusion target and the specific word determined as false to be displayed in a distinguishable manner.

### Supplementary Note 8

The summary generation system according to any of Supplementary Notes 1 to 7, wherein the specific word is a word representing a date.

### Supplementary Note 9

The summary generation system according to any of Supplementary Notes 1 to 8, wherein the specific word is set based on an attribute of the text data.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A summary generation system comprising one or more processors,
the one or more processors configured to:
acquire text data,
generate a first summary including a specific word included in the text data, based on the text data,
generate a second summary of the text data using a summary generation model generated by machine learning, and
integrate the first summary and the second summary and generate a summary corresponding to the text data.

2. The summary generation system according to claim 1, wherein
the one or more processors
parse a text in the text data,
extract the specific word, and
generate the first summary including the specific word.

3. The summary generation system according to claim 1, wherein
the one or more processors
determine whether or not the specific word is correct with reference to the text data when the second summary includes the specific word, and
generate the summary excluding the second summary when determining that the specific word is false.

4. The summary generation system according to claim 3, wherein
the one or more processors
determine that the second summary is correct when the text data includes a word matching the specific word, and
determine that the second summary is false when the text data does not include a word matching the specific word.

5. The summary generation system according to claim 1, wherein
the one or more processors
generate, as the first summary, one sentence including at least one of a plurality of the specific words.

6. The summary generation system according to claim 3, wherein
when generating the second summary of one sentence including the specific word and the second summary of one sentence not including the specific word, the one or more processors generate the summary in which the second summary including the specific word, that is correct, the second summary not including the specific word, and the first summary are integrated.

7. The summary generation system according to claim 3, wherein
when determining that the specific word is false, the one or more processors cause the second summary that is an exclusion target and the specific word determined as false to be displayed in a distinguishable manner.

8. The summary generation system according to claim 1, wherein
the specific word is a word representing a date.

9. The summary generation system according to claim 1, wherein
the specific word is set based on an attribute of the text data.

10. A summary generation method to be executed by one or more processors, the summary generation method comprising:
acquiring text data;
generating a first summary including a specific word included in the text data, based on the text data;
generating a second summary of the text data using a summary generation model generated by machine learning; and
integrating the first summary and the second summary and generating a summary corresponding to the text data.

11. A non-transitory computer-readable recording medium recording a summary generation program,
the summary generation program causing one or more processors to execute:
acquiring text data;
generating a first summary including a specific word included in the text data, based on the text data;
generating a second summary of the text data using a summary generation model generated by machine learning; and
integrating the first summary and the second summary and generating a summary corresponding to the text data.
